(19) United States
(12) Patent Application Publication
(10) Pub. No.: US 2015/0100373 A1
(43) Pub. Date: Apr. 9, 2015

(54) DEMOGRAPHICS PREDICTIONS USING MOBILE DEVICES

(71) Applicant: Vodafone IP Licensing Limited, London (GB)

(72) Inventors: Oleksiy Ignatyev, Belmont, CA (US); Volkmar Scharf-Katz, San Francisco, CA (US)

(21) Appl. No.: 14/049,941

(22) Filed: Oct. 9, 2013

(51) Int. Cl. G06Q 30/02

(52) U.S. Cl. CPC G06Q 30/0201
USPC 705/7.29

(57) ABSTRACT

A method and system predicts the demographic characteristics of people within a geographic area with cellular coverage. The method can include determining that a first mobile phone user is domiciled within a first geographic area. Upon determining that the first mobile phone user is domiciled within the first geographic area, a demographic profile can be associated with the user. The present invention can detect that the first mobile phone user has relocated domiciles to a second geographic area. The present invention can then calculate an updated demographic profile of the second geographic area by incorporating the specific demographic profile associated with the first user into a demographic profile associated with the second geographic area.

### BACKGROUND

The ability to predict demographic profiles of customers can be very important to many businesses. In particular, businesses may desire demographic information such as age, sex, income, and ethnical background when planning marketing campaigns or planning product releases. In some situations, businesses can rely upon government gathered demographic information. For example, many countries around the world perform a census or some other form of demographic gathering activity on a periodic basis where much of this information is gathered and divided up by geographical area.

For many businesses, however, government gathered demographic information is either too out-of-date or not gathered with enough frequency to be of maximum value. Specifically, many businesses would benefit from being able to track demographic data between each census. The ability to access up-to-date demographic information can provide an advantage to a business that is preparing to release or market a new product.

Additionally, a business may desire to gather demographic data about a particular geographic area during a particular time period. For instance, most demographic data is based upon the geographical area where individuals are domiciled. In many cases, however, a particular geographic area may have a different demographic make-up at night than it has during the workday. A business may be interested in knowing what the workday demographics of a particular area are when determining where to locate a new restaurant, for example. Similarly, a business may be interested in knowing the daytime demographics of the residents of the particular area when determining whether to launch a door-to-door marketing campaign in the area.

### SUMMARY

Accordingly, there is a need for methods and systems for providing up-to-date and/or geographically customizable demographics.

Embodiments disclosed herein relate to methods, systems, and computer program products for determining the demographics of a particular geographical area. In particular, in at least one embodiment, the real-time demographics of a geographical area can be approximated based upon a demographic profile that is associated with each individual mobile phone within the geographical area. Additionally, in at least one embodiment, a residential demographic can be associated with one or more mobile phones by determining the domicile of the mobile phone user.

Embodiments disclosed herein relate to a method for predicting the demographic characteristics of people within a geographic area that has cellular coverage. For example, the method can include determining that a first mobile phone user is domiciled within a first geographic area. Upon determining that the first mobile phone user is domiciled within the first geographic area, a demographic profile can be associated with the user. The present invention can then detect that the first mobile phone user has relocated domiciles to a second geographic area. The present invention can calculate an updated demographic profile of the second geographic area by incorporating the specific demographic profile associated with the first user into a demographic profile associated with the second geographic area.

Another embodiment disclosed herein relates to a system for predicting the demographic characteristics of people within a geographic area with cellular coverage. The system comprises a method for automatically identifying one or more mobile phones that are present within a particular geographic area. After identifying the mobile phones within a particular area, demographic profiles can be associated with the one or more mobile phones. Next, the present invention can determine that based upon the frequency with which a new mobile phone is present within the particular geographic area during a particular time of day that a new user associated with the new mobile phone is domiciled within the particular geographic area. In at least some embodiments, the new user may have previously been determined to be domiciled in another geographic area. Further, the present system can include updating a demographic profile associated with the particular geographic area to include information from a demographic profile associated with the new user. The demographic profile associated with the new user may be based upon a previous domicile of the new user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

To further clarify the advantages and features of the various embodiments of the invention, a more particular description will be rendered by reference to specific embodiments that are illustrated in the appended drawings. It is appreciated that these drawings depict only typical embodiments of the invention and are therefore not to be considered limiting of its scope. The various embodiments will be described and explained with additional specificity and detail through the use of the accompanying drawings in which:

FIG. 1 illustrates an embodiment of a system for determining the demographics of a geographic region;

FIG. 2A illustrates an embodiment of two geographic regions;

FIG. 2B illustrates a table describing the demographics of the two geographic regions;

FIG. 3A illustrates another embodiment of two geographic regions;

FIG. 3B illustrates another table describing the demographics of the two geographic regions;

FIG. 4A illustrates an embodiment of a geographic region;

FIG. 4B illustrates a table describing the demographics of a geographic region;

FIG. 5 depicts a flow chart illustrating an embodiment of a method for detecting the demographics of an area;

FIG. 6 depicts another flow chart illustrating an embodiment of a method for detecting the demographics of an area; and

FIG. 7 depicts another flow chart illustrating an embodiment of a method for detecting the real-time demographics of an area.

### DETAILED DESCRIPTION

Embodiments of the present invention relate to methods, systems, and computer program products for determining the demographics of a particular geographical area. In particular, in at least one embodiment, the real-time demographics of a geographical area can be approximated based upon a demographic profile that is associated with each individual mobile phone within the geographical area. Additionally, in at least one embodiment, a residential demographic can be associated with one or more mobile phones by determining the domicile of the mobile phone user.

Many modern mobile phone systems provide various methods and systems for tracking the location of the mobile phone, and by association the mobile phone user. For example, many mobile phones contain a Global Positioning System (GPS) module that provides highly accurate location information to both the mobile phone user and potentially to a cellular network that is communicating with the mobile phone. Cellular networks may also be able to track the geographic location of mobile phones that do not contain GPS modules by using various localization methods. For instance, multiple cellular receiving stations can be used to localize a mobile phone by analyzing the signal strength between each respective cellular receiving station and the mobile phone.

Once a location of a mobile phone has been determined various attributes of the mobile phone user can be inferred. For example, if the location of a mobile phone is consistently within the same geographic area between 11:00 pm and 4:00 am for an extended number of days, it can be inferred that the mobile phone user is domiciled within the geographic area. This feature may be of particular value when a home address of the mobile phone user is not otherwise known. Accordingly, in at least one embodiment the present invention provides a method for determining the geographical area in which a customer is domiciled.

Once a domicile of a mobile phone user has been determined, various demographic attributes can be inferred and associated with the mobile phone user. For instance, demographic data associated with the geographical area can be associated directly with the mobile phone user. In at least one embodiment, the demographic data can be based upon information gathered in a recent government census. For example, within the United States Census, information is gathered relating to ethnicity, race, income, education, and other specific. This previously gathered demographic data, or a subset of the data, can be associated with the mobile phone user, such that the mobile phone user is assumed to be representative of the demographics of the geographic area.

In addition to determining a domicile and associated demographics of a mobile phone user, in at least one embodiment, the present invention can also provide real-time demographics of a geographical area. For example, a cellular network can be used to identify each of the mobile phone users that are within the geographical area of interest during the time of interest. The individual demographics of each identified mobile phone user can then be accessed to determine a real-time demographic profile of the area of interest.

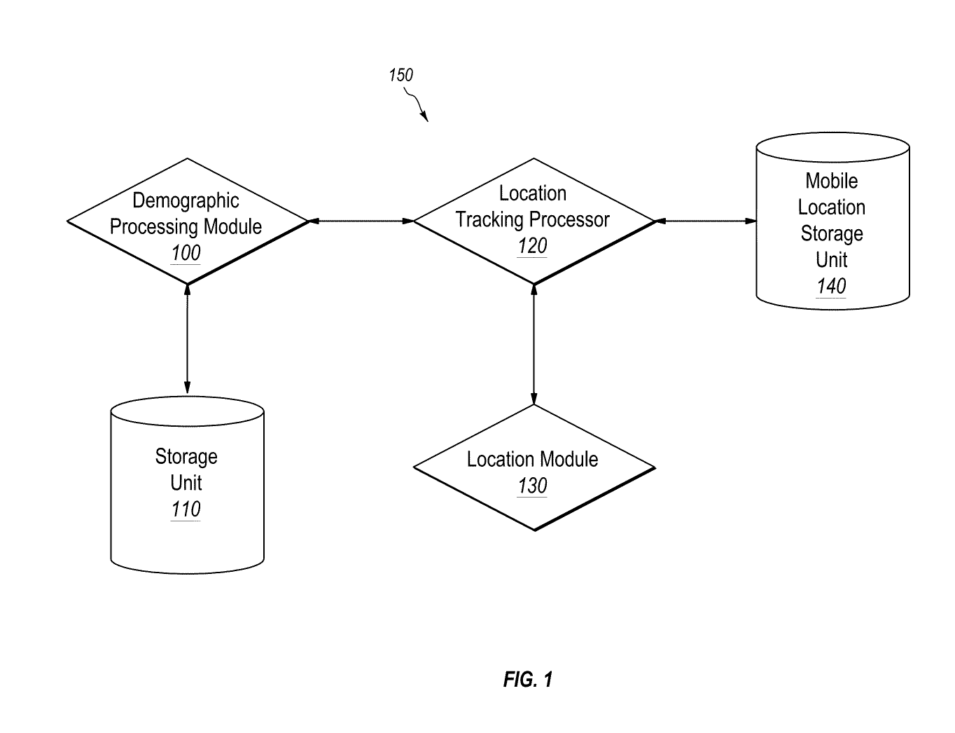

An embodiment of the present invention for performing at least some of the above-described functions is depicted in FIG. 1. FIG. 1 illustrates a demographic tracking system 150 for a cellular network. The depicted system 150 includes a demographic processing module 100, a storage unit 110, a location tracking processor 120, a location module 130, and a mobile location storage unit 140. One will understand, however, that the various modules 100, 110, 120, 130, 140 of the system 150 can be combined or separated into modules and components other than that depicted by FIG. 1 and still remain within the scope of the present invention. Additionally, modules 100, 110, 120, 130, 140 can represent hardware components, software components, or a mixture of both.

In at least one embodiment, the demographic processing module 100 is the central processing unit for determining demographic data within the system 150. The demographic processing module 100 is in communication with the storage unit 110. The storage unit 110 can store census data that was previously gathered by a governmental organization or some other organization. The storage unit 110 can also store updated demographic information that the demographic processing module 100 has calculated.

The demographic processing module 100 is also in communication with a location tracking processor 120 that provides the demographic processing module 100 with information relating to the location of various mobile phone users. In particular, the location tracking processor 120 sends information to and receives information from a location module 130. The location module 130 in turn is in communication with a variety of location determination components. For example, the location module 130 can receive location information from GPS units that are integrated into various mobile phones. Additionally, the location module 130 can use various cellular stations 210 to perform various localization techniques to determine the location of mobile phones.

When the location tracking processor 120 determines a location of a mobile phone, the location tracking processor 120 can save that location within the mobile location storage unit 140. Based upon the various locations of the mobile phone over time, the location tracking processor 120 can infer specific attributes with the mobile phone. For example, if the location tracking processor 120 identifies that a particular mobile phone has been located within a particular geographical area during nighttime hours for a threshold number of day, the location tracking processor 120 can infer that the user of the mobile phone is domiciled within the particular geographic area.

In at least one embodiment, nighttime hours can comprise the hours between 8:00 pm-8:00 am, between 9:00 pm-7:00 am, between 10:00 pm-6:00 am, between 11:00 pm-5:00 am, between 12:00 pm-4:00 am, between 1:00 am-3:00 am, or through some other span of hours that individuals would normally be sleeping. Additionally, the threshold number of days required to infer a domicile can comprise a set span of days (e.g., one week, two weeks, one month, two months, three months, etc.), or can comprise a specific ratio of days. For example, the threshold may designate a mobile phone user as being domiciled within the geographic area that is the most common nighttime location of an associated mobile phone over a period of time. For instance, the location tracking processor 120 can determine that a mobile phone user is domiciled within a particular geographic area if an associated mobile phone was located in that geographic area during night time hours more often that it was located in any other geographic area during nighttime hours over a month period, or some other period of choice. Similarly, the location tracking processor 120 can determine that a mobile phone user is domiciled within a particular geographic area if the phone is located within that area during nighttime hours at least 2 out of every 3 days.

Once a domicile for a particular mobile phone has been determined, the demographic processing module 100 can update demographic information with relation to the particular mobile phone. For example, in at least one embodiment, if the mobile phone has not been previously associated with a demographic profile, the demographic processing module 100 can associate the demographics of the geographic area of the determined domicile with the mobile phone (and by associated the mobile phone user). In at least one embodiment, this action may comprise the demographic processing module 100 assigning the mobile phone with a demographic profile derived from a governmental census. In alternative embodiments, the demographic processing module 100 may assign the mobile phone a demographic profile that has been updated by the demographic processing module 100 since the previous government census.

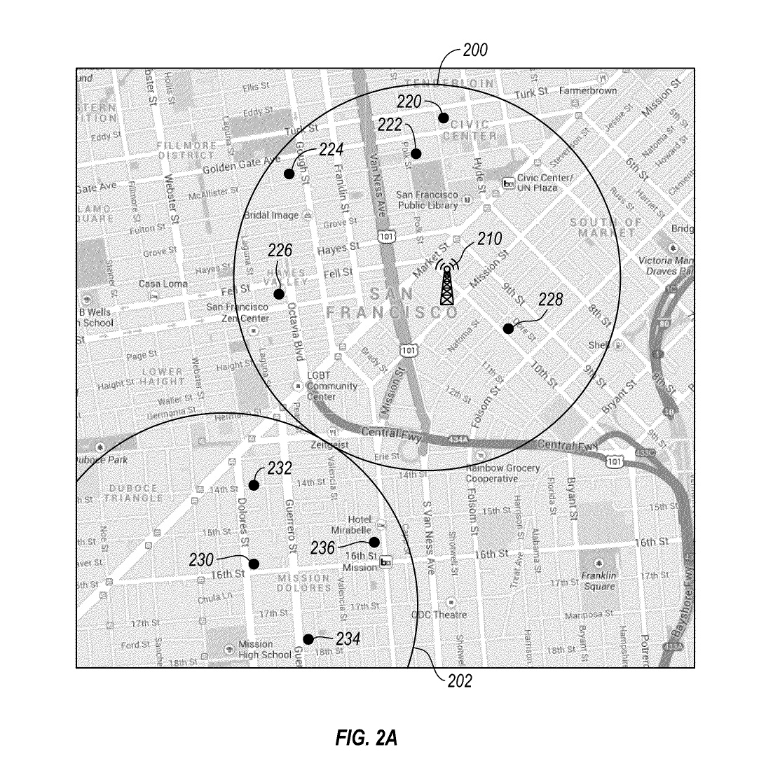

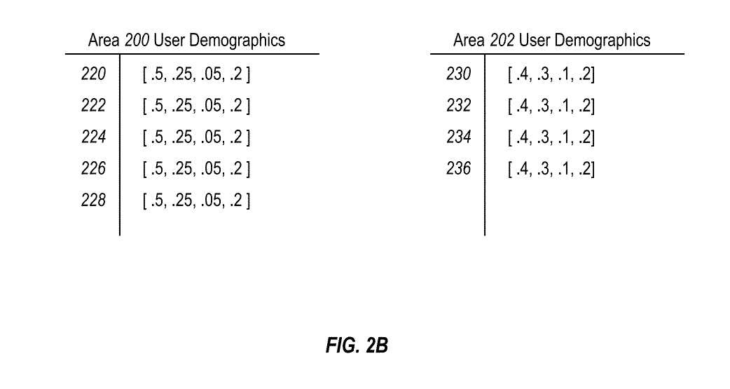

As an example, assume that the demographic processing module 100 is analyzing mobile phones within geographic areas 200 and 202, as depicted in FIG. 2A. Additionally, assume that in this particular example the demographic processing module 100 has been directed to specifically process demographic data relating to the ethnic backgrounds of people, which for simplicity in this example consist of the following a) white (not Latino/Hispanic), b) Latino/Hispanic, c) African Americans, d) Asians. One will understand that in many geographic areas actual demographic backgrounds may be substantially more diverse. In this example, however, the listed ethnicities are normalized such that together they account for 100% of the population, even though in practice a certain percentage of the population may not actually fall within the listed demographic categories.

Further, in this example, suppose, that in geographic area 200 the U.S. census has identified the following ethnical background distribution: a) white—50%, b) Latino/Hispanic—25%, c) African Americans—5%, and d) Asians—20%. In at least one embodiment, this demographic data is represented in vector form as [0.5, 0.25, 0.05, 0.2]. Similarly, suppose that in geographic area 202 the U.S. census identified the following ethnical background distribution: a) white—40%, b) Latino/Hispanic—30%, c) African Americans—10%, and d) Asians—20%. Accordingly, this demographic data can be represented in vector form as [0.4, 0.3, 0.1, 0.2]. As such, in some cases within this application a demographic profile is referred to as a demographic vector, and visa versa.

Using the vectors stated above, the demographic processing module 100 can associate each mobile phone that is determined to be domiciled within geographical area 200 or 202 with the appropriate respective demographic vector. For example, FIG. 2A depicts regions 200 and 202 each containing domiciled mobile phones 220, 222, 224, 226, 228, 230, 232, 234, and 236 respectively. As such, the demographic processing module 100 can associate each mobile phone 220, 222, 224, 226, and 228 within geographic area 200 with vector [0.5, 0.25, 0.05, 0.2], while associating mobile phones 230, 232, 234, and 236 within geographical area 202 with vector [0.4, 0.3, 0.1, 0.2].

Stated more broadly, the demographic processing module 100 can characterize the demographics within each area as a vector X⁰=(x₁,x₂,x₃,x₄), where x₁+x₂+x₃+x₄=1. Additionally, the demographic processing module 100 can associate multiple different vectors with each mobile phone, where each vector represents a different demographical attribute. For example, the demographic processing module 100 can associate a vector relating to ethnicity, a vector relating to age, and a vector relating to income with each mobile phone. Each of the associated vectors can be distinct or part of a matrix of vectors.

In addition to calculating a demographic profile associated with a mobile phone user, the demographic processing module 100 can also recalculate and update the demographic profile that is associated with a particular geographic area. For example, FIG. 2B depicts two tables containing the demographical profile of area 200 and area 202, respectively. In both areas, all of the identified mobile phone users have the same respective demographic profile. As such, the demographic processing module 100 can easily calculate that the demographic profile of area 200 is [0.5, 0.25, 0.05, 0.2] (50% white, 25% Latino/Hispanic, 5% African Americans, and 20% Asians) and that the demographic profile of area 202 is [0.4, 0.3, 0.1, 0.2] (40% white, 30% Latino/Hispanic, 10% African Americans, and 20% Asians).

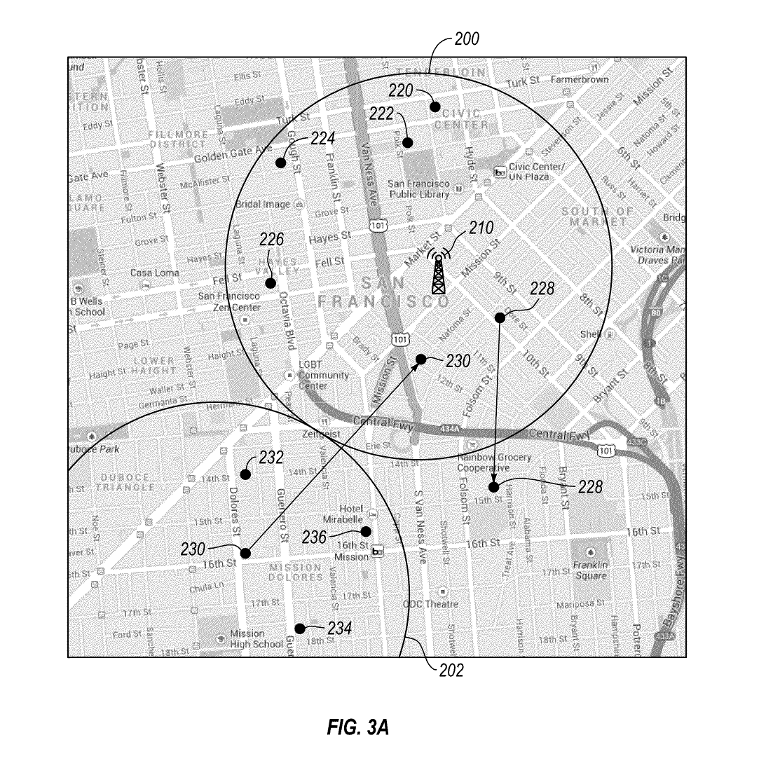

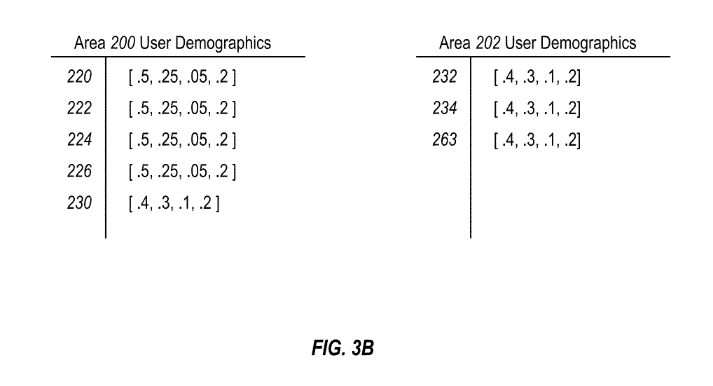

While the demographics of the mobile phone users in FIG. 2A and FIG. 2B are homogenous, one will understand that over time an areas demographics can change. For example, FIG. 3A depicts an embodiment where mobile phone user 230 has changed domiciles from area 202 to area 200. Additionally, mobile phone user 228 has changed domiciles to an address outside of both area 200 and area 202. These changes in domiciles can be determined based upon the detection techniques described above, based upon mobile phone user 230 or 228 updating a home address associated with a user account, and/or by receiving the updated addresses from some other information source.

In FIG. 3A, the updated demographics of area 200 will be calculated using an averaging function. For example, assuming that in a previous time increment the demographics of area 200 was equal to X. The location tracking processor 120 determines the number of all mobile phone users within area 200 whose current time increment domicile did not change. This number can equal N. The location tracking processor 120 then determines the number of mobile phone users that have moved into area 200. This number can be equal to M. After determining the mobile phone users that have moved to geographic area 200, the demographics processing module 100 can access the demographic profile that is associated with each relocated individual mobile phone user. These demographic profiles can be signified as D₁, D₂, D₃, . . . Dₘ. Using the above determined information, the demographics processing module 100 can recalculate the current time increment demographics vector X¹ of geographical area 200 by using the following formula:

X¹=(N*X+D₁+D₂+ . . . Dₘ)/(N+M)

FIG. 3B depicts two tables containing the updated demographic information of geographical area 200 and geographical 202. Compared to the tables depicted in FIG. 2B, Area 200 now contains one less mobile phone user with associated demographics [0.5, 0.25, 0.05, 0.2] and one additional mobile phone user with an associated demographic of [0.4, 0.3, 0.1, 0.2], while Area 202 now contains one less mobile phone user. Applying the above equation to geographical area 200 provides the following result and equation:

[0.48, 0.26, 0.06, 0.2]=(4.*[0.5, 0.25, 0.05, 0.2]+[0.4, 0.3, 0.1, 0.2])./(4+1)

Because no new mobile users with different demographic profiles moved into geographic area 202, the demographics of area 202 will remain the same, [0.4, 0.3, 0.1, 0.2]. Once the demographic processing module 100 calculates the new demographics of area 200 and 202, the updated demographics can be stored within the storage unit 110, and accessed for later calculations. Using this approach, demographics vectors corresponding to geographical areas can be recalculated for any time increment.

The above described calculations and demographics are based upon the mobile phone users that are determined to be domiciled within each respective area. This demographic information may be valuable to an advertising company in determining whether to run a particular ad campaign in that demographic area. In future calculations of demographics, each of the mobile users 220, 222, 224, 226, 230 can maintain their demographic profile as depicted in FIG. 3B, with mobile phone user 230 have the sole unique profile in the geographic area 200.

In contrast, in at least one embodiment, after updating a demographic profile for a particular geographic area, the demographic processing module 100 can cause each mobile phone user 220, 222, 224, 226, 230 to inherit the updated demographic of the geographic area. In the example described above, this would mean that after updating the demographic associated with geographic area 200, each of the mobile phone users 220, 222, 224, 226, 230 would have their individual geographic profiles updated to [0.48, 0.26, 0.06, 0.2] to reflect the updated demographic profile of geographic area 200. In future demographic calculations, mobile phone users would all be treated as if their respective demographic profile was [0.48, 0.26, 0.06, 0.2].

Similarly, when a new mobile phone that has not previously been associated with a demographic profile is detected within a particular geographic area 200, 202, the new mobile phone can inherit the demographic profile of the area where the location tracking module processor 120 determines the mobile phone to be domiciled. For example, if a new mobile phone user is determined to be domiciled within area 200, then the demographic processing unit 100 can associate the new mobile phone user with the demographic profile of geographic area 200 (e.g., [0.5, 0.25, 0.05, 0.2]).

The above description is directed towards determining the demographic profiles of various mobile phone users that are domiciled within a particular geographic area. In at least one embodiment, however, it may be beneficial to determine the real-time demographics of a particular geographic area. For example, a company that is trying to determine a location for a future restaurant may be interested in knowing the demographics of a particular geographic area during a work week lunch break.

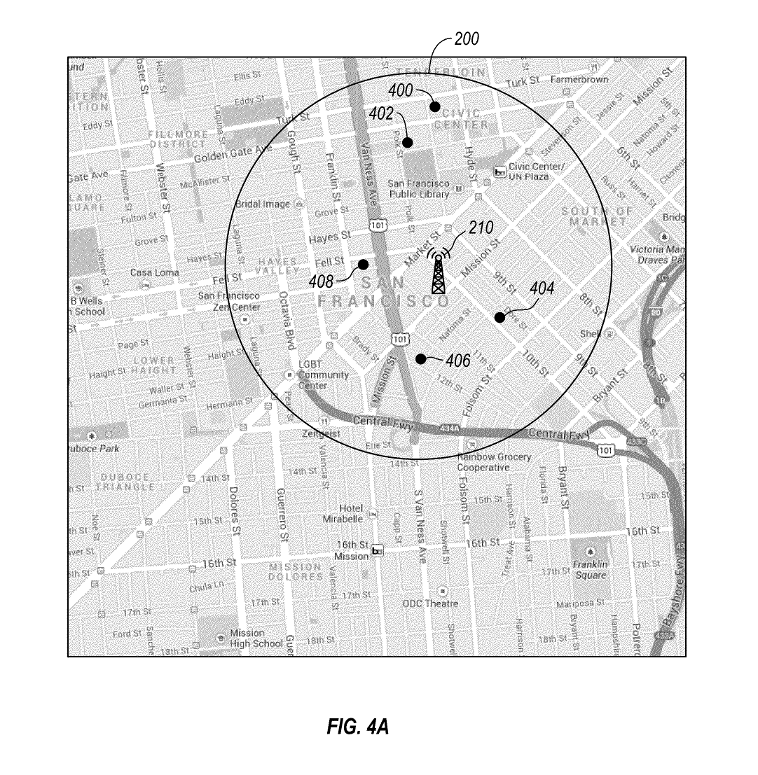

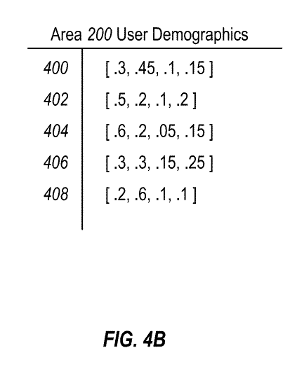

For instance, FIG. 4A depicts geographic area 200 during a work week lunch break. In the depicted example, the location tracking processor 120 identified mobile phone users 400, 402, 404, 406, and 408 within the area of interest, geographic area 200. Once the mobile phone users have been identified by the location tracking processor 120, the demographic processing module 100 can access the storage unit 110 and retrieve the demographic profile that is associated with each respective identified mobile phone user 400, 402, 404, 406, 408.

For example, FIG. 4B depicts a table containing a list of the identified mobile phone users 400, 402, 404, 406, and 408, along with the respective demographic profiles. When determining the real-time demographics of a geographic area the following equation can be used:

D_{A}=(X₁+X₂+X₃+ . . . +Xₙ)/n

Where D_{A} is equal to the demographics vector at real time t, and X₁, . . . , Xₙ are demographics vectors of the mobile users who's location, or location of their serving cell tower at time t is within the geographical area of interest. As applied to FIG. 4A the resulting equation and demographic profile of area 200 would be the following:

[0.38, 0.35, 0.1, 0.17]=([0.3, 0.45, 0.1, 0.15]+[0.5, 0.2, 0.1, 0.2]+[0.6, 0.2, 0.05, 0.15]+[0.3, 0.3, 0.15, 0.25]+[0.2, 0.6, 0.1, 0.1])/5

In other words, using the above stated formula the demographic processing module 100 can identify that the real-time demographic profile of Area 200 is [0.38, 0.35, 0.1, 0.17] (38% white, 35% Latino/Hispanic, 10% African Americans, and 17% Asians). Using the demographic profile generated from the limited number of mobile phone users, a business or customer can infer that the entire geographic area 200 has a similar demographic.

In addition to the methods described above, there are additional methods for calculating a demographic profile for a geographic area, based upon the demographics of mobile phone users. For example, a weighted moving average can be used to calculate a demographic profile for a geographic area. In this case, the demographic processing module 100 relies upon several previous demographics vectors of a given geographic area. Accordingly, a exemplary formula for calculating a weighted average demographic profile is provided below:

Xᵢ₊₁=wₖ*Xᵢ₋ₖ+wₖ₋₁*Xᵢ₋ₖ₊₁+ . . . w₁*Xᵢ₋₁+w₀*Xᵢ

In this equation, the demographics processing module 100 is predicting home demographics vector Xᵢ₊₁ at a “next” time increment i+1. The inputs to the equation include previously observed values of home demographics vectors Xⱼ at previous time increments j. Additionally, weighting factors (“wⱼ”) are applied to each previous demographic vector, such that w₀+w₁+ . . . +wₖ=1. In at least one embodiment, the weights can all be equal. In an alternate embodiment, a higher weighting can be associated with more recent demographic vectors.

An additional method that can be used to calculate current and future demographic profiles of a geographic area can include calculating a “velocity” and “acceleration” of previous demographical change. For example, the following equations can be used to calculate velocity and acceleration, respectively:

V(i)=X(i+1)−X(i)

a(i)=V(i+1)−V(i)

Velocity (“V(i)”) is calculated by calculating the demographic profile vector at time “i,” and then again at time “i+1.” The two resulting demographic vectors are then subtracted from each other to generate a “velocity” associated with the change in demographics between time interval “i” and time interval “i+1.” In some cases, however, the demographic processing module 100 will not have to calculate the demographic vector for time interval “i” and time interval “i+1,” but instead can retrieve that demographic vectors from the storage unit 110, if they were previously calculated.

After calculating a demographic velocity, the demographic processing module 100 can predict a demographic vector of a geographic area at time increment j, where j is greater than i, by using only X(i) and the previously calculated V(i) and given that all coordinates of a vector X(j) stay nonnegative:

X(j)=X(i)+(j−i)*V(i)

Similarly, the demographic processing module 100 can predict a demographics vector for a particular area at time increment j, where j is greater than i, by using a demographic vector (“X(i)”), a demographic velocity (“V(i)”) and a demographic acceleration (“a(i)”). In particular, a predicted demographic vector of a particular geographic area at time “j” can be calculated using the below equation, given that all coordinates of a vector X(j) stay nonnegative:

X(j)=X(i)+(j−i)*V(i)+a*(j−i)*(j−i−1)/2

In at least one embodiment, the demographic processing module can recalculate the estimates of V(i) and a(i), at each current time increment “i”, by using previously observed values of X(i), X(i−1) and X(i−2) and using formulas provided above.

In addition to using demographic velocity and/or acceleration to predict a future demographic, in at least one embodiment, the demographic processing module 100 can also use historical demographic data relating to other geographic areas that have similar attributes to the geographic area of interest. For example the demographic processing module 100 can divide various portions of the demographic data relating to a plurality of geographic areas into multi-dimensional “bins.” For instance, the demographic processing module 100 can create a plurality of different bins for various demographic vectors. In the above discussed exemplary cases, the bins may comprise 4-dimensions, such that the bins are sized to fit the 4-dimensional demographic vectors. Each coordinate from within a demographic vector can then fall within a single 1-dimensional bin. For example, a 1-dimensional bin may be configured to receive a coordinate relating to the percentage of white/Caucasians within a particular geographic area. After creating the bins, the demographic processing unit 100 can divide the particular demographic coordinate for the demographic vectors into the plurality of bins, such that similar vector values are placed within the same bin.

Continuing with this example, the demographic processing module 100 can now utilize the bins to predict the next time increment demographics profile for a particular geographic area. To do so, the demographics processing module 100 first identifies the bin to which current value of X(i) belongs. Then the demographics processing module 100 takes into account all observed demographics vectors Yₖ, corresponding to different geographical areas that fall within the same demographics bin as vector X(i). Next, the demographic processing module 100 observes what actually happened to all vectors Yₖ at subsequent time increments. In the below equation these values are denoted as Yₖ(+1). Using the below equation, Yₖ(+1) can be used to predict the value of X(i+1).

X(i+1)=average of (Yₖ(+1))

Additionally, the demographic processing module 100 can determine the quality of the above prediction formula by measuring the standard deviation of the Euclidian norms of differences |(Yₖ(+1)−Yₖ)|. Smaller standard deviations relate to a higher confidence in the above prediction formula. Accordingly, the demographic processing module 100 can define the demographic bin corresponding to X(i) as stable bin if:

Average (Yₖ(+1)−Yₖ)=E, and Euclidean norm |E| is very small positive number close to 0, and

Std|(Yₖ(+1)−Yₖ)|=E₁, and |E₁| is less than some small threshold value

In contrast, the demographics processing module can define a demographics bin as unstable if the above conditions are not satisfied. In general, stable bins usually are related to the homophily property, which basically states that some people “tend to live among the people similar to themselves”.

Similar to the above recited method of predicting demographics of a particular geographic area, in at least one embodiment, the demographic processing module can use a multivariate regression model. Specifically, the model can use previously observed home demographics vectors X(i), (i is less or equal to j) as inputs to predict the next time increment home demographics vector X(j+1).

Accordingly, FIGS. 1-4B depict various implementations of the present invention that are adapted to determine and update a demographic profile associated with a particular geographic area. In particular, the present invention can provide real-time or near-real-time overviews of the demographic make-up of a particular area. Additionally, the present invention can identify the demographic make-up of an area during a particular time of the day.

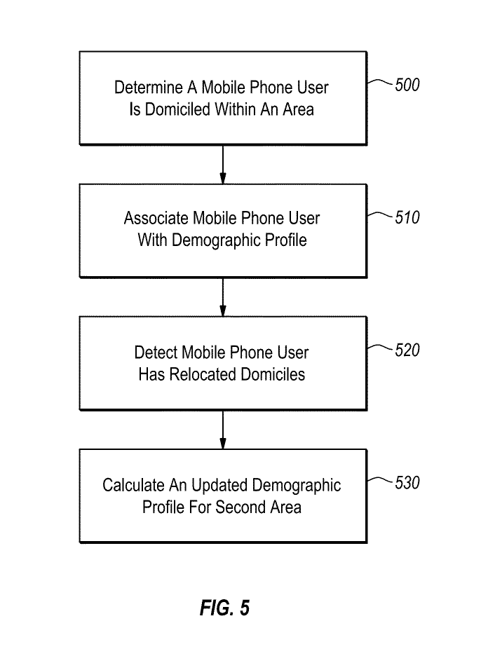

For example, FIG. 5 illustrates that a method for predicting demographic profiles can comprise act 500 of determining a mobile phone user is domiciled within an area. Act 500 includes determining that a first mobile phone user is domiciled within a first geographic area. For example, FIG. 2A shows a plurality of mobile phones users that a location tracking processor 120 has identified as being domiciled within geographic area 200.

FIG. 5 also shows that the method can include act 510 of associating mobile phone users with a demographic profile. Act 510 includes digitally associating with the first mobile phone user a specific demographic profile derived at least in part from one or more previously established demographic profiles relating to the first geographic area. For example, FIG. 2B shows a plurality of mobile phone users associated with a previously established demographic profile.

Additionally, FIG. 5 shows that the method can include act 520 of detecting a mobile phone user has relocated domiciles. Act 520 includes detecting that the first mobile phone user has relocated domiciles to a second geographic area. For example, FIG. 3A show that a location tracking processor 120 has detected that mobile phone user 202 has relocated domiciles from geographic area 230 into geographic area 200.

Further, FIG. 5 shows that the method can also include act 530 of calculating an updated demographic profile for the second area. Act 530 includes calculating an updated demographic profile of the second geographic area by incorporating the specific demographic profile associated with the first user into a demographic profile associated with the second geographic area. For example, FIG. 3B and the related description shows that demographic processing module 100 can update the demographics associated with geographic area 200 to include the demographics profile of user 230. Similarly, FIG. 3B and the related description show that demographic processing module 100 can update the demographic profile associated with a geographic area 202, 200 to exclude the demographic profile of any users that have left a particular geographic area 202 (e.g., user 230) and add the demographic profile of a new user 230 that has moved into a particular geographic area 200.

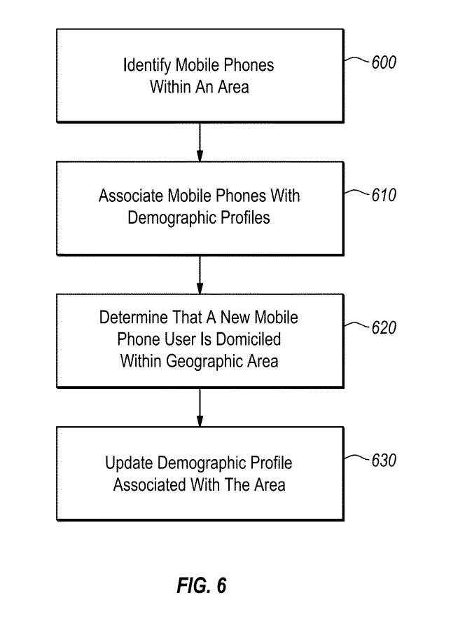

Additionally, FIG. 6 illustrates that a system for predicting demographic profiles can comprise act 600 of identifying mobile phones within an area. Act 600 includes automatically identifying one or more mobile phones that are present within a particular geographic area. For example, FIG. 2A shows a plurality of mobile phones users that a location tracking processor 120 has identified as being domiciled within geographic area 200.

FIG. 6 also shows that the system can include act 610 of associating mobile phone users with a demographic profile. Act 610 includes associating, using a computer processor, each of the one or more mobile phones with a demographic profile, wherein the demographic profile is descriptive at least of the particular geographic area. For example, FIG. 2B shows a plurality of mobile phone users associated with a previously established demographic profile.

Additionally, FIG. 6 shows that the method can include act 620 of determining that new mobile phone user is domiciled within a geographic area. Act 620 includes determining, with a computer processor, that based upon the frequency with which a new mobile phone is present within the particular geographic area during a particular time of day that a new user associated with the new mobile phones is domiciled within the particular geographic area, wherein the new user was previously determined to be domiciled in another geographic area. For example, FIG. 3A show that a location tracking processor 120 has detected that mobile phone user 202 has relocated domiciles from geographic area 230 into geographic area 200.

Further, FIG. 6 shows that the method can also include act 630 of calculating an updated demographic profile for a particular area. Act 630 includes updating, within a digital database, a demographic profile associated with the particular geographic area to include information from a demographic profile associated with the new user, wherein the demographic profile associated with the new user is based upon a previous domicile of the new user. For example, FIG. 3B and the related description shows that demographic processing module 100 can update the demographics associated with geographic area 200 to include the demographics profile of user 230.

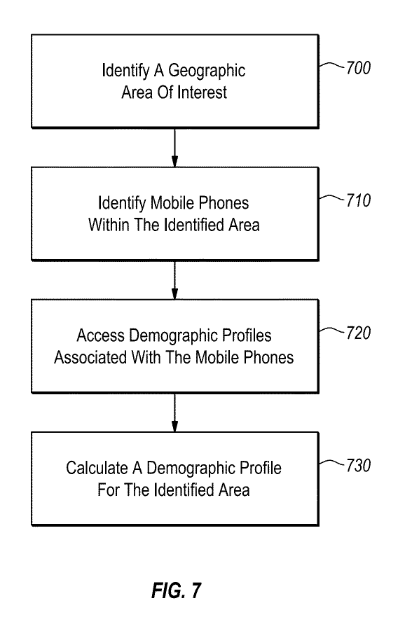

FIG. 7 illustrates that a system for predicting demographic profiles of an area in real-time can comprise act 700 of identifying a geographic area of interest. For example, FIG. 4A shows a particular geographic area 200 that has been identified as an area of interest. Specifically, the system has been directed to determine a real-time demographic profile for area 200 during a particular interval of time.

FIG. 7 also shows that the system can include act 710 of identifying mobile phones within the identified area. Act 710 includes using various methods (e.g., GPS, localization, etc.) to identify the mobile phones that are within the geographic area of interest. For example, FIG. 4A shows a plurality of mobile phones 400, 402, 408, 404, 406 that have been identified with the particular area.

Additionally, FIG. 7 shows that the method can include act 720 of accessing demographic profiles associated with the mobile phones. For example, FIG. 4B shows that a table containing demographic profiles associated with each particular mobile phone. The demographic profiles can be focused on a single demographic measure (as shown in FIG. 4B) or can be focused on a plurality of demographic measures.

Further, FIG. 7 shows that the method can also include act 730 of calculating a demographic profile for the identified area. Act 730 includes calculating a real-time demographic for a geographic area during a particular time (e.g., 12:00 PM on a Wednesday). For example, FIGS. 4A and 4B, with the accompanying description, provide an exemplary implementation of a system for determining the real-time demographics of a particular geographic area.

Accordingly, FIGS. 1-7 and the corresponding text illustrate or otherwise describe one or more components, modules, and/or mechanisms for identifying and updating demographic profiles associated with geographic areas. One will appreciate that implementations of the present invention can provide tremendous flexibility and power marketing power to a user. In particular, a user can determine up-to-date demographics for a particular area and using this information make business and marketing decisions. Methods of using the present invention are described above.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical non-transitory storage media. Computer-readable media that carry computer-executable instructions are transmission media. Thus, by way of example, and not limitation, embodiments of the invention can comprise at least two distinctly different kinds of computer-readable media: physical non-transitory storage media and transmission media.

Physical non-transitory storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In the above detailed description, reference is made to the accompanying drawings, which form a part hereof. In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element (for example first purchase information) in the claims or in the detailed description, is not meant to imply numerical sequence, but is meant to distinguish one element from another unless explicitly noted as implying numerical sequence.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method for predicting the demographic characteristics of people within a geographic area with cellular coverage, the method comprising:
determining that a first mobile phone user is domiciled within a first geographic area;
digitally associating with the first mobile phone user a specific demographic profile derived at least in part from one or more previously established demographic profiles relating to the first geographic area;
detecting that the first mobile phone user has relocated domiciles to a second geographic area; and
calculating an updated demographic profile of the second geographic area by incorporating the specific demographic profile associated with the first user into a demographic profile associated with the second geographic area.

2. The method as recited in claim 1, further comprising:
accessing a digital database comprising previously gathered demographic profiles associated with at least one geographic area with cellular coverage.

3. The method as recited in claim 2, wherein the previously gathered demographic profiles are derived from census data.

4. The method as recited in claim 1, wherein determining that the first mobile phone user is domiciled within a first geographic area comprises:
electronically identifying that a most common nighttime location of a mobile phone associated with the first mobile phone user is within the first geographic area.

5. The method as recited in claim 4, wherein nighttime comprises the hours between 1:00 am-5:00 am.

6. The method as recited in claim 1, wherein detecting that the first mobile phone user has relocated domiciles to a second geographic area comprises:
electronically determining that the most common nighttime location of the mobile phone associated with the first mobile phone user is within the second geographic area for longer than a threshold number of days

7. The method as recited in claim 1, further comprising:
identifying one or more mobile phone users that are located within the second geographic area during a particular time interval.

8. The method as recited in claim 7, further comprising:
identifying one or more demographic profiles that are associated with the respective one or more mobile phone users; and
calculating an average demographic profile for the second geographic area for the particular time interval based upon the identified one or more demographic profiles.

9. The method as recited in claim 1, wherein the updated demographic profile of the second geographic area is used in at least some future demographic calculations relating to the second geographic area.

10. A computer based system comprising one or more computer processors and including a cellular network and multiple geographical areas identifiable within the cellular network, the system predicting the demographic characteristics of people within a geographic area with cellular coverage, the system configured to perform the following:
automatically identify one or more mobile phones that are present within a particular geographic area;
associate, using a computer processor, each of the one or more mobile phones with a demographic profile, wherein the demographic profile is descriptive at least of the particular geographic area;
determine, with a computer processor, that based upon the frequency with which a new mobile phone is present within the particular geographic area during a particular time of day that a new user associated with the new mobile phone is domiciled within the particular geographic area, wherein the new user was previously determined to be domiciled in another geographic area; and
update, within a digital database, a demographic profile associated with the particular geographic area to include information from a demographic profile associated with the new user, wherein the demographic profile associated with the new user is based upon a previous domicile of the new user.

11. The system as recited in claim 10, wherein the system is further configured to perform the following:
access a digital database comprising previously gathered demographic profiles associated with at least one geographic area with cellular coverage.

12. The system as recited in claim 11, wherein the previously gathered demographic profiles includes information derived from census data.

13. The system as recited in claim 10, wherein the system is further configured to perform the following:
identify one or more mobile phone users that are located within the particular geographic area during a particular time interval.

14. The system as recited in claim 10, wherein the system is further configured to perform the following:
identify one or more demographic profiles that are associated with the respective one or more mobile phone users; and
calculate an average demographic profile for the particular geographic area for the particular time interval based upon the identified one or more demographic profiles.

15. The system as recited in claim 10, wherein the system is further configured to perform the following:
calculate an average demographic profile for the particular geographic area for the particular time interval based upon the identified one or more demographic profiles.

16. The system as recited in claim 10, wherein the system is further configured to perform the following:
predict a future demographic profile for the particular geographic area based upon a calculated demographic change velocity.

17. The system as recited in claim 10, wherein the system is further configured to perform the following:
predict a future demographic profile for the particular geographic area based upon a calculated demographic change acceleration.

18. The system as recited in claim 10, wherein the system is further configured to perform the following:
predict a future demographic profile for the particular geographic area based upon previously observed or estimated values of demographic profiles for the particular geographic area.

19. The system as recited in claim 10, wherein the system is further configured to perform the following:
predict a future demographic profile for the particular geographic area based upon previously observed or estimated values of demographic profiles for other geographic areas, which previously observed or estimated values of demographic profiles for the other geographic areas are similar to the demographic profile of the particular geographic area.

20. A computer program product for use in a system comprising one or more processors and including a cellular network and multiple geographical areas identifiable within the cellular network, a method for predicting the demographic characteristics of people within a geographic area with cellular coverage, the method comprising:
determining that a first mobile phone user is domiciled within a first geographic area;
digitally associating with the first mobile phone user a specific demographic profile derived at least in part from previously established demographic profiles relating to the first geographic area;
detecting that the first mobile phone user has relocated domiciles to a second geographic; and
calculating an updated demographic profile of the second geographic area by incorporating the specific demographic indication associated with the first user into a demographic profile associated with the second geographic area.
